(19) United States
(12) Patent Application Publication
(10) Pub. No.: US 2010/0086279 A1
(43) Pub. Date: Apr. 8, 2010

(54) Video BoomBox

(76) Inventor: Scott C. Harris, Rancho Santa Fe, CA (US)

Correspondence Address: SCOTT C HARRIS;Law Office of Scott C Harris, Inc, P O BOX 1389, Rancho Santa Fe, CA, 92067-1389, US

(21) Appl. No.: 12/245,768

(22) Filed: Oct. 5, 2008

(51) Int. Cl. H04N 5/91

(52) U.S. Cl. 386/66

(57) ABSTRACT

A video player which plays a video program. The playing is automatically paused when the screen is not attached to the playing device.

### BACKGROUND

An audio “boombox” is a slang term for certain devices that allows playing of audio, e.g., reproducing music from a media. The media can include cassette tapes, CDs, radio, or other medial Speakers play the sound.

### SUMMARY

The present application describes a standalone unit which reproduces audio and also produces an output indicative of video. In one embodiment, the presence of a video screen is detected, and used to change the playing based on whether that screen is present.

The embodiment discloses a stand-alone system which can produce an output for a video screen. The system can be produce video for that video screen, while playing through the audio speakers within the unit.

### BRIEF DESCRIPTION OF THE DRAWINGS

FIG. 1 shows a basic block diagram.

### DETAILED DESCRIPTION

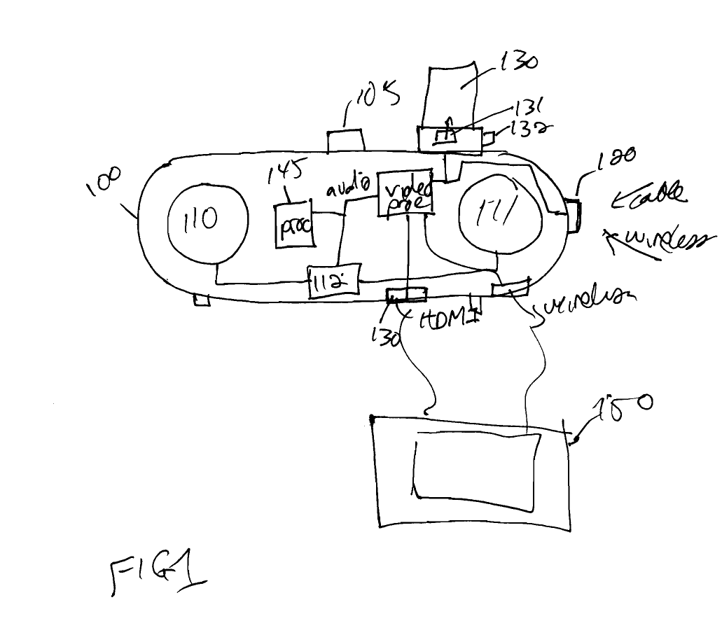

An embodiment is shown in FIG. 1. The embodiment 100 may be a stand-alone unit, for example with a carrying handle 105, and first and second speakers 110, 111. The speakers are driven by an audio amplifier 112 which may be an integrated circuit or a group of circuits within the housing. The system may have a number of different kinds of inputs, and may also have an integrated media reader, e.g., DVD player, USB input for reading an MP3 that is attached to the USB input, TV tuner or other.

A first wideband input 120 may be a wired or wireless connection, and may receive video content over a channel, e.g., over a cable connection, or a wireless connection such as WiMAX or wireless ethernet. Input 120 may be a receiver of broadband content. There can also be a receiver port 129 for an stand-alone media player. This can be a connector of a form for interfacing with a media player such as 131, or a USB connector such as 132. A video processor 133 can receive video from any of the input ports, e.g., media player port 129, or data channel port 120.

The device 100 produces an audio output which is amplified by the audio amplifier 112 and played through speakers 110, 111. When video-including information is received, the device 100 also produces information indicative of the played video that is temporally related to, e.g., synchronized with, the audio that is being played. The video output may be output via a hardwired video data connector such as an HDMI connector 136, or alternatively via R,G,B component connectors, or any other kind of wired connector. The video can also be sent via wireless HDMI or wireless ethernet or wireless USB or any other wireless protocol through port 137 to an external video display 150.

However connected, the display shows video or images based upon a signal that has been received and decoded and/or processed by video processor 133. The controlling processor 145 may control the operation according to presets, or according to a standard, or according to a program. A remote control 146 can also interface with unit 100, causing processor 145 to carry out certain actions under control of the remote, as conventional.

In operation, the processor 145 may determine whether a video unit such as 150 is actually “attached” in the sense of receiving video from the unit 100. The communication between the unit 100 and the video screen 150 may be carried out by communicating with the video unit either wired or wirelessly. The video communication occurs via a driver that allows detection of whether a video unit is actually attached and receiving the signal. If the video screen 150 is wire-connected, the wire connection can be detected as drawing current or receiving the signal. A wireless video connection is detected by handshaking signals between the unit 100 and video unit 150, e.g., format handshaking signals which communicate the speed or the link, or encryption handshaking signals that communicate encryption information so that the digital video is communicated in an encrypted way to the display unit. This encryption may be used to prevent copying of the digital source.

In operation according to one embodiment, the system detects whether the video display is connected when the data being played includes video content. When the video unit is connected, the video is played as usual. When the video unit is not connected, the playing of the source is “paused”, stopping all playing until the video unit is again connected. This may pause the media players, or digitize and store the incoming channel data 120 in memory 147 (which may be sized to store 15-30 minutes of digitized video) to take up playing at the leave-off point when the video player is reattached.

An advantage of this embodiment is that when the video unit is shut off, this system does not have the sound playing through the speakers as though the video unit were still attached.

Also, when wireless transmission formats such as wireless HDMI are used to connect the unit to a display screen, temporary disruptions in the transmission to the display, like people walking into a spot that dampens the display communication, or some kind of temporary RF interference, or any other, the viewers do not miss any of the program. Instead, they automatically take up watching where they left off.

Finally, when this system is used with an external monitor, e.g. a computer monitor, shutting off that monitor automatically pauses the playing. This means that only one device needs to be turned off, not both.

In another embodiment, when the video unit is turned off or not present, the sound is automatically muted. This prevents the situation where sound is being played from a video source without the video being present.

Another advantage of this system is that it can automatically turn any monitor of any type into a television system. While FIG. 1 shows an output port in HDMI format, of course the output can be in any format including composite video, or DVI-D or analog computer output.

The system includes a video processor 133r, which can automatically act as a tuner by decoding video programming received over the channel port, e.g., airwave, cable, Wimax or other sources. Therefore, any unused computer monitor can automatically become a TV with built-in stereo and the enhancements described herein. The stereo and tuner can be used for new monitors as new monitors become available. The video processor 145 can have its firmware updated to bring in new enhancements. Hence, this system can help avoid hardware obsolescence.

Moreover, the device 100 can be carried from room to room, automatically automatically displaying on a new monitor in the new room, and automatically pausing when out of monitor range. For example, in one embodiment, a user might start watching a television program using the system 100 on a first monitor. Then, when they want to move into another room, they simply take the device and connect it to a second monitor. Disconnecting the first monitor automatically stops the playing of the program, and reconnecting to the next monitor starts playing again. When the connection between unit 100 and monitor 150 is wireless, the “disconnection”, “reconnection” is simply getting into range of the new monitor.

While the above has described this as including the media player 130, it should be understood that any other kind of media player could be used, such as playing directly from a USB key, or DVD player.

The general structure and techniques, and more specific embodiments which can be used to effect different ways of carrying out the more general goals are described herein.

Although only a few embodiments have been disclosed in detail above, other embodiments are possible and the inventor intends these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art. For example, other formats of transmission can be used to get information to the unit 100, and from the unit 100 to the monitor, including power line networking, Bluetooth, infra-red connection, and others.

The device can be battery operated, or operate from AC power. A non-portable device, e.g, in a housing intended to be installed and not moved frequently, is also contemplated.

Also, the inventor intends that only those claims which use the words “means for” are intended to be interpreted under 35 USC 112, sixth paragraph. Moreover, no limitations from the specification are intended to be read into any claims, unless those limitations are expressly included in the claims. The computers described herein may be any kind of computer, either general purpose, or some specific purpose computer such as a workstation. The computer may be an Intel (e.g., Pentium or Core 2 duo) or AMD based computer, running Windows XP or Linux, or may be a Macintosh computer. The computer may also be a handheld computer, such as a PDA, cellphone, or laptop.

The programs may be written in C or Python, or Java, Brew or any other programming language. The programs may be resident on a storage medium, e.g., magnetic or optical, e.g. the computer hard drive, a removable disk or media such as a memory stick or SD media, wired or wireless network based or Bluetooth based Network Attached Storage (NAS), or other removable medium or other removable medium. The programs may also be run over a network, for example, with a server or other machine sending signals to the local machine, which allows the local machine to carry out the operations described herein.

Where a specific numerical value is mentioned herein, it should be considered that the value may be increased or decreased by 20%, while still staying within the teachings of the present application, unless some different range is specifically mentioned. Where a specified logical sense is used, the opposite logical sense is also intended to be encompassed.

What is claimed is:

1. A system comprising:
a video playing circuit, which produces a video output based on a source data and produce an audio output based on said source data, where said audio output is temporally related to said video output;
a port for an external video display screen; and
a controller, detecting a connection of said external display screen to said port, and automatically stopping said audio output based on detecting that the external display screen is not attached to said port.

2. A system as in claim 1, wherein said controller automatically pauses playing by said video playing circuit to stop said audio output, based on said detecting.

3. A system as in claim 2, wherein said playing is playing information from a live video feed, and said automatically pausing causing said information to be stored during said pausing.

4. A system as in claim 1, wherein said port produces information to be sent over a wire, and detects a video screen connected to and receiving said wired information.

5. A system as in claim 1, wherein said port produces wireless information, and detects a video screen receiving said wireless information.

6. A system as in claim 1, further comprising an audio playing circuit coupled to said video playing circuit, wherein said audio playing circuit produces sound output based on said audio output.

7. A system as in claim 1, wherein said video playing circuit includes a port which receives said source data from an external media player.

8. A system as in claim 2, wherein said controller operates to pause an externally attached media player, based on said detecting that the external display screen is not attached to said port.

9. A method comprising:
producing a video output based on a source data and producing an audio output based on said source data, where said audio output is temporally related to said video output;
detecting a connection of said external display screen to a port that receives said video output, and automatically stopping said audio output based on detecting that the external display screen is not connected to said port.

10. A method as in claim 9, further comprising automatically pausing playing of said video and audio output based on said detecting that said external display screen is not connected to said port.

11. A method as in claim 10, wherein said producing comprises producing information from a live video feed, and said automatically pausing causing said video output and said audio output to be stored during said pausing.

12. A method as in claim 9, wherein said connection comprises information that is sent over a wire, and said detecting detects a video screen connected to and receiving wire information.

13. A method as in claim 9, wherein said connection comprises information that is sent over a wireless connection, said detecting comprises detecting a video screen receiving said wireless information.

14. A method as in claim 9, further comprising producing sound output based on said audio output.

15. A method as in claim 9, further comprising receiving said source data from an external media player.

16. A method as in claim 15, operating to pause the externally attached media player, based on said detecting that the external display screen is not attached to said port.

17. A method comprising watching a video program on a first video monitor in a first location;
detecting a movement to a location near a second video monitor in a second location; and
automatically continuing watching said video program on said second video monitor in said second location.

18. A method as in claim 17, wherein said continuing comprises continuing said watching without missing any part of the video programming.

19. A method as in claim 17, further comprising pausing a video during a time between handoff between the first and second video monitors.

20. A method as in claim 17, further comprising pausing a video when said player is out of range of said first video monitor.

21. A method as in claim 17, wherein said watching a video program comprises watching a program being played from an external player.
